(19) United States
(12) Patent Application Publication
(10) Pub. No.: US 2026/0338473 A1
(43) Pub. Date: Oct. 29, 2026

(54) Conveying Device and Cooling Furnace

(71) Applicant: Hymson Laser Technology Group Co., Ltd., Shenzhen, Guangdong (CN)

(72) Inventors: Xiaohuang Zhou, Shenzhen, Guangdong (CN); Chao Xue, Shenzhen, Guangdong (CN); Qi Long, Shenzhen, Guangdong (CN); Shengqing Zheng, Shenzhen, Guangdong (CN)

(21) Appl. No.: 18/841,670

(22) PCT Filed: Dec. 27, 2023
(86) PCT No.: PCT/CN2023/142236

§ 371 Date: Aug. 26, 2024

(30) Foreign Application Priority Data
Dec. 11, 2023 (CN) 202311693425.0

(51) Int. Cl. F27B 9/12; B65G 17/12; B65G 17/34; F27D 9/00; H01M 50/609

(52) U.S. Cl. CPC F27B 9/12; B65G 17/12; B65G 17/34; F27D 9/00; H01M 50/609; B65G 2201/02; F27B 2009/126; F27D 2009/0075

(57) ABSTRACT

Disclosed are a conveying device and a cooling furnace, where the conveying device includes first brackets and second brackets spaced apart in a first direction and arranged opposite to the first brackets, and the first brackets and the second brackets together define a limiting space for locating secondary cells. The conveying device further includes an adjustment assembly to which the first brackets and the second brackets are slidably connected, and which are slidable in a first direction with respect to the adjustment assembly, so that the limiting space can be increased or decreased in size in the first direction, and so that the limiting space can be adapted to the size of the secondary cells in the first direction. The conveying device provided by the present invention can be adapted to convey the secondary cells having different sizes, thereby improving the applicability of the cooling furnace having the conveying device.

### TECHNICAL FIELD

The present invention relates to the field of battery manufacturing equipment, and in particular to a conveying device and a cooling furnace.

### BACKGROUND ART

At present, the battery industry has been widely developed due to economic development and environmental protection requirements. The batteries in the prior art generally require injection of an electrolyte inside the cell case, and the cell case needs to be heated and dried before the electrolyte is injected. After the cell case is dried, it needs to be cooled to a certain temperature to inject liquid, and the common cooling method is natural cooling, but this cooling method will lead to a long production cycle and low production efficiency. However, cooling the battery before injecting the liquid by means of air cooling can effectively increase the cooling rate of the battery to shorten the production cycle of the product and increase the production efficiency, which requires a conveying device capable of conveying the battery in large quantities. In the related art, since the size specifications of the secondary cells corresponding to different products are different, to ensure the delivery stability of the secondary cells, the secondary cells of different size specifications generally need to be designed with conveying devices of different size specifications to effectively deliver the secondary cells. In the related art, the applicability of the conveying device is not high, resulting in an increase in the manufacturing cost of the conveying device, which is not conducive to reducing the production cost of the secondary cell.

### SUMMARY OF THE INVENTION

A main object of the present invention is to propose a conveying device and a cooling furnace aimed at solving the technical problem of how to improve the applicability of the conveying device.

To achieve the above object, the present invention proposes a conveying device used for a cooling furnace, including:
first brackets;
second brackets arranged opposite at intervals to the first brackets in a first direction, the first brackets and the second brackets together defining a limiting space for locating secondary cells; and
an adjustment assembly to which both the first brackets and the second brackets are slidably connected, and the first brackets and the second brackets being both slidable in the first direction relative to the adjustment assembly to increase or decrease the size of the limiting space in the first direction.

In some embodiments, the conveying device further includes:
a drive unit including a drive chain in the form of a loop arranged about an axis parallel to a second direction, the second direction being arranged in the lateral direction and perpendicular to the first direction, the drive chain being configured to rotate around the axis, the drive chain connecting the plurality of first brackets and the plurality of second brackets in a circumferential direction of the axis, the drive chain driving each of the first brackets and each of the second brackets to reciprocate in the circumferential direction.

In some embodiments, the drive unit is provided with a first locating position and a second locating position arranged at intervals and adjacent to the first locating position, the limiting space has a first size when the adjustment assembly is mounted in the first locating position, the limiting space has a second size when the adjustment assembly is mounted in the second locating position, and the first size is greater than the second size.

In some embodiments, a side of the adjustment assembly in a third direction is connected to the drive chain, a side of the adjustment assembly facing away from the drive chain in the third direction is connected to the first bracket and the second bracket, the third direction is perpendicular to the first direction and the second direction, and the drive chain drives the adjustment assembly to reciprocate in the circumferential direction.

In some embodiments, the adjustment assembly includes a plurality of first adjustment members and a plurality of second adjustment members, the first brackets are removably connected to the first adjustment members and the second brackets are removably connected to the second adjustment members, the first brackets are configured to move in the first direction relative to the first adjustment members and the second brackets are configured to move in the first direction relative to the second adjustment members such that the first brackets and the second brackets are adjustable in size in the first direction.

In some embodiments, the conveying device further includes:
a support provided between the first bracket and the second bracket, and the support is arranged at intervals at the first bracket, the second bracket, and the support is used for supporting the secondary cells, where a side wall of a side of the first bracket adjacent to the second bracket, and the support and the side wall of the side of the second bracket adjacent to the first bracket together define the limiting space.

In some embodiments, the conveying device further includes:
limiting blocks, where the plurality of limiting blocks are arranged at intervals in the second direction on the first brackets and the second brackets, the second direction is arranged in the lateral direction and perpendicular to the first direction, and the limiting blocks are detachably connected to the first brackets and the second brackets, each of the limiting blocks arranged on the first brackets is aligned with each of the limiting blocks arranged on the second brackets in the first direction, an adjacent one of the limiting blocks arranged on the first brackets, an adjacent one of the limiting blocks arranged on the second brackets, and the first brackets and the second brackets together define the limiting space.

In some embodiments, protrusions are provided on two sides of the limiting block provided opposite in the first direction.

In some embodiments, the two sides of the first bracket provided opposite in the first direction and the two sides of the second bracket provided opposite in the first direction are usable for locating the secondary cells.

The second aspect of the present invention also provides a cooling furnace, including:
the conveying device as described in any of the embodiments above; and
a cooling fan for providing a cooling airflow to the secondary cells placed on the conveying device.

In some embodiments, the cooling fan is adapted to deliver a cooling airflow in the second direction toward the secondary cells; or
the cooling fan is adapted to deliver a flow of cooling airflow in a third direction towards the secondary cells.

Compared with the prior art, the advantageous effects of the present invention are as follows:
in the technical solution of the present invention, the conveying device includes first brackets and second brackets, where the second brackets are spaced in a first direction and arranged opposite to the first brackets, and the first brackets and the second brackets together define a limiting space for locating the secondary cells. The conveying device further includes an adjustment assembly to which the first brackets and the second brackets are slidably connected, and which are slidable in a first direction with respect to the adjustment assembly, so that the limiting space defined by the first brackets and the second brackets together can be increased or decreased in size in the first direction, and so that the limiting space can be adapted to the size of the secondary cells in the first direction. The present invention provides a conveying device in which a limiting space defined by a first bracket and a second bracket provided in the conveying device can be used to locate the secondary cells, and a distance in a first direction between the first bracket and the second bracket can be adjusted by an adjustment assembly, compared to a conveying device in the related art, so that the conveying device can be adapted to convey the secondary cells having different sizes, thereby improving applicability of a cooling furnace having the conveying device.

### BRIEF DESCRIPTION OF THE DRAWINGS

To explain the technical solutions in the embodiments or the prior art of the present invention more clearly, a brief description will be given below referring to the accompanying drawings which are used in the description of the embodiments or the prior art, and it is obvious that the drawings in the description below are merely some embodiments of the present invention, and it would have been obvious for a person skilled in the art to obtain other drawings according to the structures shown in these drawings without involving any inventive effort.

FIG. 1 is a schematic structural diagram showing a cooling furnace according to an embodiment of the present invention;

FIG. 2 is an enlarged schematic diagram showing a conveying device taken at section A of FIG. 1 according to an embodiment of the present invention;

FIG. 3 is an enlarged schematic diagram showing a conveying device taken at section B of FIG. 2 according to an embodiment of the present invention;

FIG. 4 is a schematic structural diagram showing a first bracket and a second bracket according to another embodiment of the present invention; where the first bracket includes a first bracket table, the second bracket includes a second bracket table, and vents are arranged between the first bracket and the second bracket.

### REFERENCE NUMERALS

100—cooling furnace;
110—conveying device;
111—limiting space; 112—vent; 113—first bracket; 1131—first bracket table; 114—second bracket; 1141—second bracket table; 115—support; 116—limiting block; 1161—protrusion;
120—adjustment assembly; 121—first adjustment member; 122—second adjustment member;
130—drive unit; 131—first locating position; 132—second locating position;
Y-first direction; X-second direction; Z-third direction.

The objects, features and advantages of the present invention will be further described referring to the accompanying drawings in conjunction with the embodiments.

### DETAILED DESCRIPTION OF THE INVENTION

The embodiments of the present invention will now be described more fully hereinafter referring to the accompanying drawings, in which embodiments of the present invention are shown. It is to be understood that the embodiments described are only a few, but not all embodiments of the present invention. Based on the embodiments of the present invention, all other embodiments obtained by a person skilled in the art without inventive effort fall within the scope of the present invention.

To improve the performance of the secondary cell, it is necessary to first heat and dry the secondary cell case and then cool the secondary cell case in the manufacturing process of the secondary cell, especially in the preliminary work of injecting the electrolyte into the secondary cell case. The conventional cooling methods mainly include natural cooling and air cooling, where in the natural cooling mode, the cooling time of the secondary cell is long, which results in a long product production cycle and low production efficiency. If air cooling is used, a conveying device capable of conveying the secondary cells in large quantities is required. In the related art, in the manufacturing process of the secondary cells, conveying devices having different size specifications are generally used for conveying the secondary cells having different size specifications. That is, in the related art, each of the conveying devices is only suitable for conveying the secondary cells of a specific size specification, and when the size of the secondary cells is changed, it is necessary to design the conveying device again according to the size specification of the secondary cells so that the conveying device can stably convey the secondary cells.

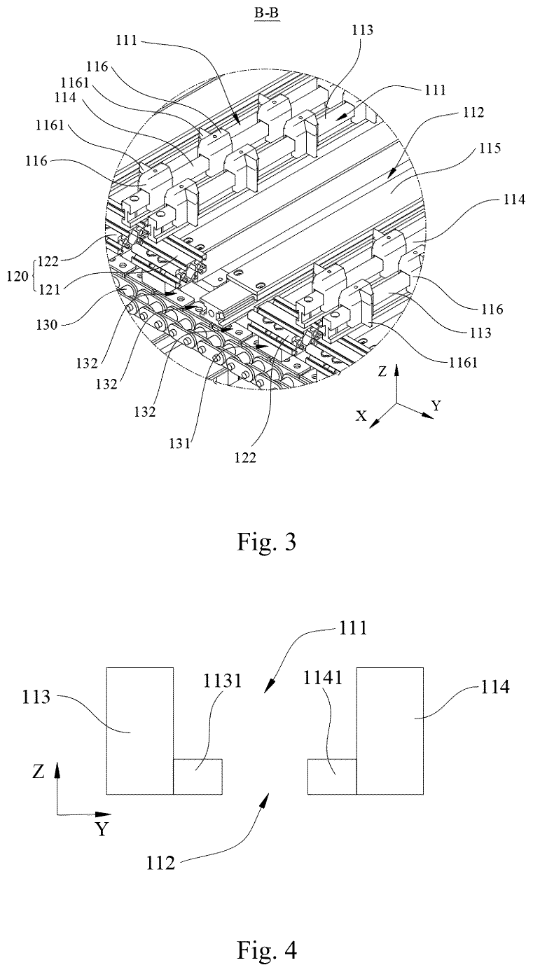

In view of this, referring to FIGS. 1 to 4, the present invention proposes a conveying device 110 that can be used for a cooling furnace 100 and also for a device or an apparatus required to convey the secondary cells under other process flows in the secondary cell manufacturing process. Referring to FIG. 3, the conveying device 110 includes a first bracket 113 and a second bracket 114 arranged at intervals in a first direction Y, and the first bracket 113 and the second bracket 114 are provided opposite in the first direction Y, such that the first bracket 113 and the second bracket 114 together define a limiting space 111 therebetween, and the limiting space can be used to locate the secondary cells. It is noted that embodiments, the conveying device 110 has a plurality of first brackets 113 and a plurality of second brackets 114, each first bracket 113 being arranged at intervals at each second bracket 114 in the first direction Y. In some embodiments, the limiting space 111 may be used to locate one secondary cell. In other embodiments, the limiting space 111 may be used to locate a plurality of secondary cells. The conveying device 110 also includes an adjustment assembly 120 to which the first bracket 113 and the second bracket 114 are slidably coupled. The first bracket 113 and the second bracket 114 are each slidable relative to the adjustment assembly 120 in the first direction Y such that the size of the limiting space 111 defined by the first bracket 113 and the second bracket 114 in the first direction Y can be increased or decreased. The adjustment assembly 120 may be a sliding rail structure, a linear bearing, or the like, capable of adjusting the distance between the first bracket 113 and the second bracket 114.

In some embodiments, the first bracket 113 and the second bracket 114 may both be slidably connected to the same adjustment assembly 120. In other embodiments, the first bracket 113 and the second bracket 114 may be slidably connected to different adjustment assemblies 120, respectively. Specifically, the sizes of the first bracket 113 and the second bracket 114 in the first direction Y can be adjusted according to the size specification of the secondary cells, so that the size of the limiting space 111 in the first direction Y can be adapted to the secondary cells, thereby achieving the effect of stably conveying the secondary cells. It should be noted that the present invention provides a conveying device 110 that can be adapted to simultaneously convey secondary cells of different sizes. In embodiments, for the convenience of expression, a first battery and a second battery are defined below, and the size specification of the first battery is different from the size specification of the second battery, and the first battery and the second battery are exemplified. The size of the part of the first bracket 113 and the part of the second bracket 114 in the first direction Y can be adjusted by the adjustment assembly 120 according to the size specification of the first battery, and the size of the part of the first bracket 113 and the part of the second bracket 114 in the first direction Y can be adjusted by the adjustment assembly 120 according to the size specification of the second battery. That is, the conveying device 110 can simultaneously convey the first battery and the second battery having different size specifications at this time. Of course, the conveying device 110 may simultaneously convey a plurality of secondary cells having different sizes, not limited to simultaneously conveying the first cell and the second cell.

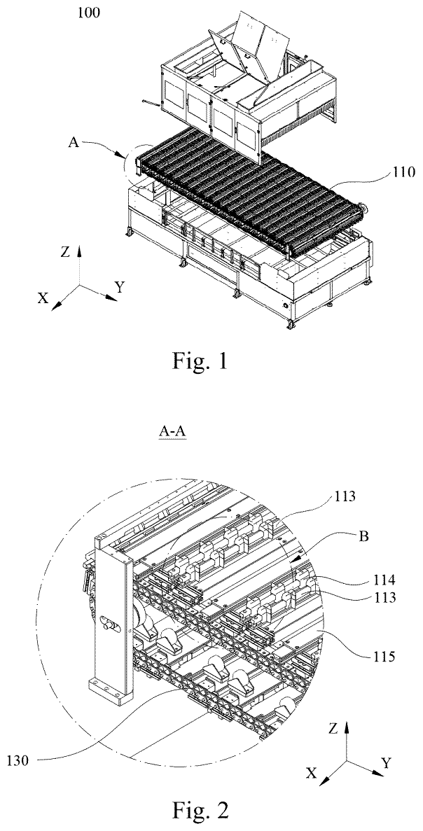

Referring to FIGS. 2 and 3, in some embodiments, the conveying device 110 further includes a drive unit 130 that includes a drive chain. For ease of presentation, the following defines a second direction X arranged in the lateral direction and perpendicular to the first direction Y, and defines an axis parallel to the second direction X. The drive chain has an annular shape arranged about the axis, and the drive chain is configured to be rotatable about the axis. In the circumferential direction of the axis, a plurality of first brackets 113 and a plurality of second brackets 114 are connected to a drive chain capable of driving each of the first brackets 113 and the second brackets 114 to reciprocate in the circumferential direction of the axis. In some embodiments, the drive unit 130 may also include a belt structure capable of performing a similar function as a drive chain during secondary cell conveyance. In other embodiments, the drive unit 130 may further include a plurality of drive wheel structures to which a plurality of first brackets 113 and a plurality of second brackets 114 are arranged alternately and at intervals, and the drive unit 130 and the first brackets 113 and the second brackets 114 may eventually assume a crawler-type structure. The drive wheel structure can drive the first brackets 113 and the second brackets 114 to move around the drive wheel, so that the secondary cells interposed between the first brackets 113 and the second brackets 114 can move therewith, thereby allowing the conveying device 110 to achieve the effect of conveying the secondary cells. For ease of presentation, a drive chain is exemplified below. In embodiments, the secondary cells are provided between the first brackets 113 and the second brackets 114, and when the drive chain rotates about the axis, the first bracket 113 and the second bracket 114 connected to the drive chain can move along with the movement of the drive chain, so that the secondary cells provided between the first bracket 113 and the second bracket 114 can move along with the first bracket 113 and the second bracket 114 in the first direction Y to realize the conveyance of the secondary cells.

Referring to FIG. 3, in some embodiments, the adjustment assembly 120 is removably connected to the drive unit 130. The drive unit 130 may be provided with a plurality of first locating positions 131 and a plurality of second locating positions 132 arranged at intervals and adjacent to the first locating positions 131. When the adjustment assembly 120 is removably connected to the first locating position 131, the limiting space 111 has a first size, which may be the size of the limiting space 111 in the first direction Y or the size of the limiting space 111 in the second direction X.

When the adjustment assembly 120 is removably connected to the second locating position 132, the limiting space 111 has a second size, and similarly, the second size may be the size of the limiting space 111 in the first direction Y, the second size may be the size of the limiting space 111 in the second direction X, etc. The first size is greater than the second size, i.e. the adjustment assembly 120 is mounted in the first locating position 131, the time limiting space 111 can locate larger secondary cells.

In some embodiments, the second locating positions 132 are arranged at intervals at the first locating positions 131 in the first direction Y. That is, when the adjustment assembly 120 is removably connected to the first locating position 131, the second locating position 132 is configured to be a pre-installed position where a substantial change in the distance of the first bracket 113 from the second bracket 114 in the first direction Y is required.

In some embodiments, a plurality of second locating positions 132 may be adjacent to and arranged at intervals at a single first locating position 131. That is, the adjustment assembly 120 may be connected to a single first locating position 131 having a plurality of second locating positions 132 arranged in the first direction Y adjacent thereto. In other embodiments, the plurality of second locating positions 132 may also be provided adjacent to and arranged at intervals at a combined locating position included of the plurality of first locating positions 131. That is, the adjustment assembly 120 may be connected to a plurality of first locating positions 131. A plurality of second locating positions 132 arranged in the first direction Y are arranged adjacent to the combined locating position consisting of the plurality of first locating positions 131 in the first direction Y. The arrangement of the first locating position 131 and the second locating position 132 enables the conveying device 110 to increase the degree of adjustment of the size of the limiting space 111 in the first direction Y, resulting in a higher applicability of the conveying device 110.

In some embodiments, one side of the adjustment assembly 120 in the third direction Z is detachably connected to the drive chain, and the first bracket 113 and the second bracket 114 are slidably connected to a side of the adjustment assembly 120 facing away from the drive chain in the third direction Z. In one embodiment, the first bracket 113 and the second bracket 114 may also be slidably connected to a side of the adjustment assembly 120 in the second direction X and adjacent to the limiting space 111. The third direction Z is perpendicular to the first direction Y and the second direction X. As the drive chain moves along the circumferential direction of the axis, the adjustment assembly 120 connected to the drive chain, and the first bracket 113 and the second bracket 114 connected to the adjustment assembly 120 can move along with the movement of the drive chain, so that the secondary cells placed between the first bracket 113 and the second bracket 114 can move along with the first bracket 113 and the second bracket 114 in the first direction Y to realize the conveyance of the secondary cells. In some embodiments, to improve the cooling effect of the secondary cells, the drive chain can reciprocate in the circumferential direction of the axis to increase the contact time of the secondary cells with the cooling airflow. In other embodiments, one side of the adjustment assembly 120 in the second direction X is removably connected to one side of the drive chain in the second direction X, and one side of the first bracket 113 and the second bracket 114 in the third direction Z is removably connected to one side of the adjustment assembly 120 in the third direction Z.

Referring to FIG. 3, in some embodiments, the adjustment assembly 120 includes a plurality of first adjustment members 121 to which the first bracket 113 is removably coupled and a plurality of second adjustment members 122 to which the second bracket 114 is removably coupled. In one embodiment, the first bracket 113 may also be slidably connected to the first adjustment member 121 and the second bracket 114 may also be slidably connected to the second adjustment member 122. The first adjustment member 121 and the second adjustment member 122 are spaced apart in the first direction Y, the first bracket 113 can switch the connection position in the first direction Y with the first adjustment member 121, and the second bracket 114 can switch the connection position in the first direction Y with the second adjustment member 122, so that the size of the first bracket 113 and the second bracket 114 in the first direction Y can be increased or decreased, and thus the size of the limiting space 111 in the first direction Y can be adjusted according to the size specification of the secondary cells, so that the conveying device 110 can smoothly convey the secondary cells. In other embodiments, the adjustment assembly 120 may also include a third adjustment member, which is defined to distinguish from the first adjustment member 121 and the second adjustment member 122 for ease of presentation. The third adjustment member may be configured as a continuous slide rail structure arranged along the circumferential side of the drive chain, the third adjustment member may also be a linear bearing or the like. The first bracket 113 and the second bracket 114 are arranged at intervals on the third adjustment member in the first direction Y, and the size of the limiting space 111 in the first direction Y can be increased or decreased by adjusting the connection positions of the first bracket 113 and the second bracket 114 on the third adjustment member according to the size specification of the secondary cell.

In one embodiment, the first adjustment member 121 may have the same structure as that of the second adjustment member 122. In another embodiment, the first adjustment member 121 may also have a structure different from that of the second adjustment member 122. In one embodiment, the size of the first adjustment member 121 in the first direction Y may be equal to that of the second adjustment member 122 in the first direction Y. In another embodiment, the size of the first adjustment member 121 in the first direction Y may also be unequal to that of the second adjustment member 122 in the first direction Y.

Referring to FIGS. 3 and 4, in some embodiments, the conveying device 110 is further provided with a vent 112 provided between the first bracket 113 and the second bracket 114 and in communication with the limiting space 111. That is, the side of the first bracket 113 in the first direction Y and adjacent to the second bracket 114 and the side of the second bracket 114 in the first direction Y and adjacent to the first bracket 113 together define a vent 112, and the vent 112 can supply the cooling airflow to the limiting space 111, so that the secondary cells located in the limiting space 111 can directly contact the cooling airflow, thereby achieving cooling. In one embodiment, each vent 112 may correspond to a secondary cell, respectively. In another embodiment, each vent 112 may correspond to a plurality of secondary cells. In yet another embodiment, each secondary cell may correspond to a plurality of vents 112. The profile shape of the vent 112 may be circular, rectangular, arch runway shaped, etc.

In some embodiments, referring to FIG. 3, the conveying device 110 further includes a support 115 provided between the first bracket 113 and the second bracket 114, which may be removably connected to the drive chain to enable the support 115 to move with the drive unit 130. In the first direction Y, the gap between the first bracket 113 and the support 115, and the gap between the support 115 and the second bracket 114 may each be configured as a vent 112. The secondary cells may be placed between the first bracket 113 and the second bracket 114, and support effect is achieved by the support 115. That is, the limiting space 111 is defined by the side of the first bracket 113 adjacent to the second bracket 114, the side of the support 115 adjacent to the secondary cell, and the side of the second bracket 114 adjacent to the first bracket 113. The cooling airflow can flow into the limiting space 111 between the first bracket 113 and the support 115, and between the support 115 and the second bracket 114, thereby cooling the secondary cells.

In other embodiments, to achieve the support effect of the secondary cells in the limiting space 111, referring to FIG. 4, a side of the first bracket 113 adjacent to the second bracket 114 is provided with a first bracket table 1131, a side of the second bracket 114 adjacent to the first bracket 113 is provided with a second bracket table 1141, and the first bracket table 1131 and the second bracket table 1141 together define the vent 112. Both ends of the secondary cells in the first direction Y are respectively adjacent to or in contact with a side of the first bracket 113 adjacent to the second bracket 114, a side of the second bracket 114 adjacent to the first bracket 113, and a side of the secondary cells adjacent to the vent 112 are supported by the first bracket table 1131 and the second bracket table 1141. Referring to FIG. 3, the arrangement of the first bracket 113, the secondary cells, and the second bracket 114 in the first direction Y may be such that the first bracket 113, the secondary cells, the second bracket 114, the first bracket 113, the secondary cells, the second bracket 114 . . . are sequentially and cyclically provided.

In some embodiments, to improve the volumetric utilization of the conveying device 110, first bracket tables 1131 are provided on two sides of the first bracket 113 provided opposite in the first direction Y and second bracket tables 1141 are provided on two sides of the second bracket 114 provided opposite in the first direction Y. That is, two sides of the first bracket 113 provided opposite in the first direction Y can be used for locating the secondary cells, and two sides of the second bracket 114 arranged opposite in the first direction Y can be used for locating the secondary cells. Specifically, the arrangement of the first bracket 113, the secondary cells, and the second bracket 114 in the first direction Y may be such that the first bracket 113, the secondary cells, the second bracket 114, the secondary cells, the first bracket 113, the secondary cells . . . are sequentially and cyclically provided. That is, two sides of the second bracket 114 provided opposite in the first direction Y can together define the limiting space 111 with one side of the first bracket 113 arranged adjacent thereto in the first direction Y.

In some embodiments, to prevent the secondary cells from moving in the lateral direction within the limiting space 111 during conveyance, the conveying device 110 further includes a limiting block 116, see FIG. 3. The first bracket 113 and the second bracket 114 are both provided with a plurality of limiting blocks 116 arranged at intervals, and the disposition position of the limiting blocks 116 on the second bracket 114 in the first direction Y corresponds to the disposition position of the limiting blocks 116 on the first bracket 113. The adjacent limiting blocks 116 provided on the first bracket 113, the first bracket 113, the second bracket 114, and the adjacent limiting blocks 116 provided on the second bracket 114 together define the limiting space 111. Both ends of the secondary cells in the first direction Y can be respectively accommodated between adjacent limiting blocks 116 on the first bracket 113 and between adjacent limiting blocks 116 on the second bracket 114. It should be noted that, in one embodiment, the space between adjacent limiting blocks 116 on the first bracket 113 and the second bracket 114 may accommodate only one secondary cell. In another embodiment, the space between adjacent limiting blocks 116 on the first bracket 113 and the second bracket 114 may accommodate a plurality of secondary cells.

To adapt the secondary cells to different products, it is necessary to design secondary cells of different size specifications according to different products. To make the conveying device 110 as suitable for conveying secondary cells of different size specifications as possible, in some embodiments, the limiting blocks 116 are detachably connected to the first bracket 113 and the second bracket 114. The distance in the lateral direction of the adjacent limiting blocks 116 provided on the first bracket 113 and the second bracket 114 can be adjusted according to the size of the secondary cells, so that the secondary cells can be effectively located by the limiting blocks 116 and the limiting spaces 111. In the process of driving the secondary cells in the first direction Y by the conveying device 110, since the size of the limiting space 111 in the lateral direction is not adapted to the size of the secondary cells in the lateral direction, the secondary cells are caused to shake in the limiting space 111, thereby causing the secondary cells to scrape, collide, etc. with other parts or secondary cells. In some embodiments, the conveying device 110 with the removable limiting blocks 116 is capable of simultaneously conveying secondary cells of different sizes.

Referring to FIG. 3, in some embodiments, two sides of the limiting blocks 116 provided opposite in the first direction Y are further provided with protrusions 1161. The protrusions 1161 can separate and limit adjacent secondary cells during secondary cell conveyance. The protrusions 1161 are provided to prevent the surfaces of the secondary cells from scratching the limiting blocks 116 when the secondary cells rock in the limiting space 111 during conveyance. That is, when the secondary cells rock, the protrusions 1161 can contact and restrain the secondary cells before the limiting blocks 116 could do. In one embodiment, the protrusions 1161 are made of a soft material having elasticity, and may be rubber, foam, silica gel, etc. In other embodiments, the limiting blocks 116 are respectively provided with a buffer layer adjacent to the side of the secondary cell, and the buffer layers have elasticity, so that the secondary cells can be located more effectively while absorbing the displacement amount of the secondary cells rocking during conveyance. In other embodiments, the protrusions 1161 may also be provided on a side of the limiting blocks 116 in the first direction Y.

Referring to FIG. 1, a second aspect of the present invention also provides a cooling furnace 100 including a conveying device 110 as described in any of the embodiments above. The cooling furnace 100 further includes a cooling fan capable of providing a cooling airflow to the secondary cells moving with the conveying device 110 to improve the cooling efficiency of the secondary cells.

In some embodiments, the cooling fan may be arranged on one side of the conveying device 110 that is arranged in the lateral direction to provide a cooling airflow flowing in the lateral direction to the secondary cells. In another embodiment, the cooling fan may be further arranged at a side of the conveying device 110 facing away from the secondary cells in the third direction Z, i.e., the cooling fan may be arranged at the bottom of the secondary cells, so that the cooling fan can provide the secondary cells with a cooling airflow flowing in the third direction Z. The cooling airflow can be circulated into the limiting space 111 through the vent 112, thereby rapidly cooling the secondary cells placed in the limiting space 111. The cooling furnace 100 according to the present invention can cool a plurality of secondary cells having different size specifications at the same time, and has high applicability while ensuring high cooling efficiency.

In some embodiments, the conveying device 110 may be only partially accommodated in the cooling furnace 100, the conveying device 110 is operated such that the secondary cells are conveyed to the cooling furnace 100 along with the conveying device 110 from the previous processing step, and a cooling fan provided to the cooling furnace 100 can provide a cooling airflow in the cooling furnace 100 so that the secondary cells entering the cooling furnace 100 can be cooled down while moving along with the conveying device 110. The cooled secondary cells continue to move with the conveying device 110 and are conveyed out of the cooling furnace 100 to the next processing step. In other embodiments, the conveying device 110 may be completely accommodated in the cooling furnace 100, the secondary cells are conveyed to the conveying device 110 accommodated in the cooling furnace 100 by other conveying devices, and driven by the conveying device 110 so that the secondary cells can move relative to the cooling furnace 100, and the secondary cells are discharged from the cooling furnace 100 by the conveying device 110 after they are cooled, and then conveyed to the next processing step by other conveying devices.

It should be noted that, if a directional indication (such as up, down, left, right, front, rear . . . ) is involved in an embodiment of the present invention, the directional indication is only used for explaining the relative positional relationship, movement condition and the like between components at a certain posture, and if the certain posture is changed, the directional indication is changed accordingly.

In addition, if there is a description of “first”, “second”, etc. in an embodiment of the present invention, the description of “first”, “second”, etc. is for descriptive purposes only and is not to be construed as indicating or implying a relative importance or implicitly indicating the number of technical features indicated. Thus, the features defined by “first” and “second” may explicitly or implicitly include at least one of the features. In addition, where “and/or” appears throughout the text, the meaning includes three juxtaposed versions, taking “A and/or B” as an example, including versions of A, or versions of B, or versions satisfying both A and B. In addition, the technical solutions between the various embodiments can be combined with each other, but it must be realized by a person skilled in the art, and when the combination of technical solutions appears contradictory or cannot be realized, it should be considered that the combination of technical solutions does not exist and is not within the scope of protection of the present invention.

While the foregoing is directed to embodiments of the present invention, other and further embodiments of the present invention may be devised without departing from the basic scope thereof, and the scope thereof is determined by the claims that follow.

1. A conveying device used for a cooling furnace, comprising:
first brackets;
second brackets arranged opposite at intervals to the first brackets in a first direction, the first brackets and the second brackets together defining a limiting space for locating secondary cells; and
an adjustment assembly to which both the first brackets and the second brackets are slidably connected, and the first brackets and the second brackets being both slidable in the first direction relative to the adjustment assembly to increase or decrease the size of the limiting space in the first direction.

2. The conveying device according to claim 1, further comprising:
a drive unit comprising a drive chain having an annular shape arranged around a circumferential side of an axis, the axis being parallel to a second direction, the second direction being arranged in the lateral direction and perpendicular to the first direction, the drive chain being configured to rotate around the axis, the drive chain connecting the plurality of first brackets and the plurality of second brackets in a circumferential direction of the axis, the drive chain driving each of the first brackets and each of the second brackets to reciprocate in the circumferential direction.

3. The conveying device according to claim 2, wherein
the drive unit is provided with a first locating position and a second locating position arranged at intervals and adjacent to the first locating position, the limiting space has a first size when the adjustment assembly is mounted in the first locating position, the limiting space has a second size when the adjustment assembly is mounted in the second locating position, and the first size is greater than the second size.

4. The conveying device according to claim 3, wherein
a side of the adjustment assembly in a third direction is connected to the drive chain, a side of the adjustment assembly facing away from the drive chain in the third direction is connected to the first bracket and the second bracket, the third direction is perpendicular to the first direction and the second direction, and the drive chain drives the adjustment assembly to reciprocate in the circumferential direction.

5. The conveying device according to claim 1, wherein
the adjustment assembly comprises a plurality of first adjustment members and a plurality of second adjustment members, each of the first adjustment members and each of the second adjustment members are arranged at intervals and alternately in the first direction, the first brackets are removably connected to the first adjustment members and the second brackets are removably connected to the second adjustment members, the first brackets are configured to move in the first direction relative to the first adjustment members and the second brackets are configured to move in the first direction relative to the second adjustment members such that the first brackets and the second brackets are adjustable in size in the first direction.

6. The conveying device according to claim 1, further comprising:
a support arranged at intervals between the first bracket and the second bracket, the support being used for supporting the secondary cells, wherein a side wall of a side of the first bracket adjacent to the second bracket, and the support and the side wall of the side of the second bracket adjacent to the first bracket together define the limiting space.

7. The conveying device according to claim 1, further comprising:
limiting blocks, wherein the plurality of limiting blocks are arranged at intervals in the second direction on the first brackets and the second brackets, the second direction is arranged in the lateral direction and perpendicular to the first direction, and the limiting blocks are detachably connected to the first brackets and the second brackets, each of the limiting blocks arranged on the first brackets is aligned with each of the limiting blocks arranged on the second brackets in the first direction, an adjacent one of the limiting blocks arranged on the first brackets, an adjacent one of the limiting blocks arranged on the second brackets, and the first brackets and the second brackets together define the limiting space.

8. The conveying device according to claim 7, wherein
protrusions are provided on two sides of the limiting block provided opposite in the first direction.

9. The conveying device according to claim 1, wherein
the two sides of the first bracket provided opposite in the first direction and the two sides of the second bracket provided opposite in the first direction are usable for locating the secondary cells.

10. A cooling furnace, comprising:
the conveying device according to claim 1; and
a cooling fan for providing a cooling airflow to the secondary cells placed on the conveying device.

11. A cooling furnace, comprising:
the conveying device according to claim 2; and
a cooling fan for providing a cooling airflow to the secondary cells placed on the conveying device.

12. A cooling furnace, comprising:
the conveying device according to claim 3; and
a cooling fan for providing a cooling airflow to the secondary cells placed on the conveying device.

13. A cooling furnace, comprising:
the conveying device according to claim 4; and
a cooling fan for providing a cooling airflow to the secondary cells placed on the conveying device.

14. A cooling furnace, comprising:
the conveying device according to claim 5; and
a cooling fan for providing a cooling airflow to the secondary cells placed on the conveying device.

15. A cooling furnace, comprising:
the conveying device according to claim 6; and
a cooling fan for providing a cooling airflow to the secondary cells placed on the conveying device.

16. A cooling furnace, comprising:
the conveying device according to claim 7; and
a cooling fan for providing a cooling airflow to the secondary cells placed on the conveying device.

17. A cooling furnace, comprising:
the conveying device according to claim 8; and
a cooling fan for providing a cooling airflow to the secondary cells placed on the conveying device.

18. A cooling furnace, comprising:
the conveying device according to claim 9; and
a cooling fan for providing a cooling airflow to the secondary cells placed on the conveying device.
